(19) United States
(12) Patent Application Publication
(10) Pub. No.: US 2011/0189372 A1
(43) Pub. Date: Aug. 4, 2011

(54) PROTEIN-FREE CREAMERS, STABILIZING SYSTEMS, AND PROCESS OF MAKING SAME

(75) Inventors: Alexander A. Sher, Dublin, OH (US); Winnie Octavia, Delaware, OH (US); Edsel Nicolas Palag, Hilliard, OH (US); James Tuot, West Palm Beach, FL (US)

(73) Assignee: NESTEC S.A., Vevey (CH)

(21) Appl. No.: 12/745,378

(22) PCT Filed: Nov. 26, 2008
(86) PCT No.: PCT/EP08/66185

§ 371 Date: Sep. 28, 2010

(30) Foreign Application Priority Data
Nov. 29, 2007 (US) 11947532

(51) Int. Cl. A23L 2/385; A23G 1/00; A23F 5/00; A23F 3/00; A23L 2/02; A23L 2/39

(52) U.S. Cl. 426/593; 426/590; 426/594; 426/597; 426/599

(57) ABSTRACT

Protein-free creamer compositions and stabilizing systems contained therein. The creamer composition includes an emulsifying component of at least two low molecular weight emulsifiers in relative amounts sufficient to provide a stabilized emulsion, a cellulose component including a blend of microcrystalline cellulose and carboxymethylcellulose in an amount sufficient to maintain homogeneity of the composition; and a carrageenan gum component present in an amount sufficient to maintain homogeneity of the composition. The creamer composition can be in the form of a shelf stable aseptic liquid creamer that is stable for at least about 9 months, an extended-shelf life (ESL) liquid creamer that is stable for at least about four months at refrigeration, or a powder that is stable for at least 24 months at ambient conditions. The creamer composition provides sufficient whitening capacity and a pleasant mouth feel without discernable feathering and without discernable fat separation when added to liquid beverages.

### FIELD OF INVENTION

The present invention relates to protein free creamers, stabilizing systems contained therein, and the process of making the creamers and stabilizing systems. More particularly, the present invention relates to compositions for non-dairy Extended Shelf Life (ESL) and, aseptically packaged, shelf-stable liquid creamers, and powder creamers, and to the processes of making the creamers.

### BACKGROUND OF THE INVENTION

Creamers are used as whitening agents with hot and cold beverages such as coffee, cocoa, and tea. Creamers are also often used in the powder or particulate form as replacement for milk or cream, with cereal or in cooking, for example. Creamers are available in different flavors and often vary in terms of desired qualities such as mouth-feel, body, and texture.

Creamers (or whiteners) are available in liquid or powder forms. Powdered forms tend to be less able to simulate the qualities of traditional dairy creamers, such as color, body and texture, and often fail to achieve complete dissolution.

Fresh or refrigerated dairy creamers usually provide a good mouth-feel, but their tendency to spoil rapidly, even under refrigeration conditions, makes their use inconvenient. This disadvantage can be overcome by a non-dairy creamer, but the challenge still remains to create a homogeneous extended shelf-life (ESL) or aseptic liquid product which has constant manageable viscosity and is stable during storage for several months at refrigerated and ambient temperatures, respectively. The main challenges for powder creamers are good solubility when added to beverages, without feathering, sedimentation and other physico-chemical instability issues.

The market of non-dairy coffee creamers as coffee whiteners is highly growing, and the US is the market leader for this type of product. There is also an increased demand for low fat and non fat creamers. Because fat helps achieve emulsion, it is an added challenge to provide a creamer that is low or non fat, with the desired stability, color, texture, body, and flavor.

When added to cold or hot beverage such a coffee, the creamer should provide a good whitening capacity, dissolve rapidly, and remain stable with no feathering and/or sedimentation, and provide a superior taste. It is noted that physical stability is particularly difficult to achieve in a hot, acidic environment. The creamer must also provide a superior taste.

Several patents, such as European patent application No. 0 457 002 and U.S. Pat. No. 3,935,325 describe coffee creamers that are made of water, vegetable oil, protein or protein hydrolysate, carbohydrates, buffering salt, emulsifiers and other ingredients. However, these coffee whiteners are not shelf-stable.

U.S. Pat. No. 4,748,028 patent discloses an aseptic fluid coffee whitener and process for preparing the same. The process includes performing UHT sterilization of a mixture of water, vegetable fat, emulsifiers, a milk protein, salt and other ingredients; cooling; homogenizing; and further cooling; and filling the resulting liquid in an aseptic container under aseptic conditions. The main disadvantage of this coffee whitener is the high level of fat in the creamer, and the insufficient whitening power of the creamer with a reduced fat level. The creamer is also stable against browning only under refrigeration conditions (up to 4 months).

U.S. Pat. No. 4,784,865 describes dairy coffee whitener including low fat milk, non fat dry milk, an emulsifier that is preferably made of mono-di-glycerides, and TiO₂ as a whitening agent. The product is pasteurized and remains stable under refrigerated and non-refrigerated conditions for at least 90 and 30 days, respectively. Because the whitener lacks any stabilizing systems, severe sedimentation of TiO₂ during the storage can be expected. Further, this product is not aseptically processed, so an extended shelf life (at least 6 months) cannot be achieved.

U.S. Pat. No. 5,571,334 patent describes a starch-based opacifying agent, methods of manufacture thereof, and food and non-food formulations containing the opacifying agent. The agent includes an opacifier (e.g. TiO₂) incorporated in a starch matrix. However, the creamer in the disclosure is not aseptically processed, so an extended shelf life (at least 6 months) cannot be achieved. Moreover, a large amount of sodium caseinate is used to achieve emulsion stability of the creamer.

PCT application WO 2007/044782 describes an aseptic liquid non dairy creamer with an emulsifier level of at least 1% in order to achieve a stable emulsion. The emulsifiers are combined with a milk protein such as calcium caseinate, sodium caseinate, or potassium caseinate in order to achieve stability of the creamer.

In sum, presently existing creamer technology requires the use of proteins in order to achieve emulsion stability. Proteins are known as strong emulsifiers. Thus, milk proteins, such as casein, sodium caseinate and whey proteins, are used due to their unique emulsifying properties. However, addition of proteins to severe heat treated (UHT) liquid coffee creamers may lead to sedimentation due to protein denaturation and lower water solubility of the proteins or their derivatives. Further, proteins in powder creamers may lead to sedimentation and flocculation after creamer reconstitution in hot beverages, especially in acidic environment. Additionally, competition between proteins and low molecular weight emulsifiers may lead to emulsion instability resulting in product creaming.

Another disadvantage in using proteins such as casein and sodium caseinate in creamers is clumping that results in ESL or aseptic liquid creamers during storage. For instance, a “plug” may form overnight when the creamer is stored at refrigerated, room, or elevated temperatures, making pouring difficult and the product unusable. Furthermore, when added to coffee, feathering may result from emulsion instability of the protein in this hot, acidic environment.

Finally, with the increasing cost of proteins such as casein, the reduction or elimination of proteins in creamers is desirable. The challenge in creating a low or no protein creamer is achieving a stable emulsion without phase separation (e.g. creaming, gelation, syneresis) during storage and after reconstitution in beverages, especially in hot and acidic beverage.

Thus, there is a need for ESL and aseptic liquid creamers, as well as powder creamers that are protein-free, but still maintain the desired properties of fresh creamers, without instability problems that are associated with milk proteins such as casein. Specifically, protein-free creamers must have good physico-chemical stability (without creaming and sedimentation) throughout their shelf life, and a pleasant mouth-feel (without feathering and fat separation) when added to liquid beverages such as coffee.

### SUMMARY OF THE INVENTION

The invention set forth herein satisfies the unmet needs of the art by providing a stable, protein free creamer, in a liquid or powder form that maintains its stability over an extended period of time, and also remains stable when added to a beverage such as coffee. The protein free creamer composition of the invention generally includes an emulsifying component including at least two different molecular weight emulsifiers in relative amounts sufficient to provide a stabilized emulsion; a cellulose component including a blend of two different cellulose compounds in an amount sufficient to maintain homogeneity of the composition; and a carrageenan gum (also referred as gum) component present in an amount sufficient to maintain homogeneity of the composition. This creamer composition can be in the form of (a) an aseptic liquid creamer that is stable at ambient temperature for at least about 9 months before opening, (b) a liquid creamer that has an extended-shelf life (ESL) and is stable for at least about two months at refrigeration temperatures, or (c) a powder that is stable for at least 24 months at ambient temperatures. In use, the liquid aseptic creamer, the liquid ESL creamer or the powder creamer can provide sufficient whitening capacity and a pleasant mouth feel without discernable feathering and without visually discernable fat separation when added to liquid beverages.

Preferably, the emulsifying component includes the combination of at least one low Hydrophobic/Lipophilic Balance (HLB) emulsifier and at least one medium HLB emulsifier. The low and medium HLB emulsifiers can be present together in an amount of about 0.05 to 0.8% by weight of the total composition, and in a weight ratio of about 5:1 to about 1:20. The low HLB emulsifier can be a monoglyceride, diglyceride, acetylated monoglyceride, sorbitan trioleate, glycerol dioleate, sorbitan tristearate, propyleneglycol monostearate glycerol, monooleate and monostearate, or a combination thereof The medium HLB emulsifier is sorbitan monooleate, propylene glycol monolaurate, sorbitan monostearate, calcium stearoxyl-2-lactylate, glycerol sorbitan monopalmitate, soy lecithin, diacetylated tartaric acid esters of monoglycerides, or a combination thereof. In one preferred embodiment, the low HLB emulsifier is a monoglyceride, and the medium HLB emulsifier is an acid ester of a monoglyceride.

The cellulose component is a blend of microcrystalline cellulose (MCC) and carboxymethylcellulose (CMC) present in a total amount of about 0.05 to about 1 percent by weight of the composition, with the MCC and CMC present in a weight ratio of about 3:1 to about 30:1. The carrageenan gum component can be a kappa carrageenan gum, an iota carrageenan gum, or a combination thereof and is present in an amount of about 0.005 to about 0.1 percent by weight of the composition. In a preferred embodiment, the carrageenan gum component is a combination of a kappa and an iota carrageenan in a weight ratio of about 6:1 to about 1:10.

The creamer can also include one or more of a pH buffer, a sweetener in an amount of about 0.1 to about 50 percent by weight of the composition, or a vegetable oil in an amount of about 0.1 to about 33 percent by weight of the composition. The creamer can be full-fat, low-fat or non-fat, and have a total solids content between about 5 to about 98 percent by weight of the composition.

Additionally, the creamer can include a whitening agent in an amount sufficient to provide further whitening to an aqueous media to which the creamer is added. In one embodiment, whitening agent is titanium dioxide, which can be present in an amount of about 0.1 to about 1 percent by weight of the composition, with a particle size of about 0.1 to about 0.7 microns.

Powder creamers compositions prepared in accordance with embodiments of the invention can have a particle size ranging from about 100 to about 4000 microns.

Embodiments of the invention are also directed to a composition that includes the creamer described herein, with water in an amount sufficient to make a liquid creamer. These compositions contain the cellulose component in an amount of 0.05 to 1.0% by weight; the gum component present in an amount of 0.005 to 0.1% by weight; the emulsifying component in an amount of 0.05 to 0.8% by weight; and water in an amount of 35 to 95% by weight.

Additional embodiments of the invention are directed to a beverage of an aqueous liquid and the creamer composition set forth herein, with the creamer being present in an amount sufficient to provide a creaming effect to the beverage. The beverage can have a solids content ranging from about 0.5 to about 10 percent by weight of the total beverage. The beverage can further include a beverage-forming component such as coffee, tea, chocolate or a fruit drink.

Further embodiments of the invention are directed dairy replacements made of the creamer composition set forth herein. These dairy replacements are suitable for use with food or for use in cooking.

The invention also relates to a process of manufacture of these creamer compositions which comprises providing the emulsifying components, cellulose components, and carrageenan gum components in powder form; and dissolving the powder components in hot water with agitation. A sweetener or whitening agent, in powder form, can also be added into the hot water with agitation. Thereafter, a vegetable oil or fat can be added to the hot water to produce a mixture of all components, followed by subjecting the mixture to UHT treatment, homogenization, cooling, and filling in containers under aseptic conditions. If desired, the mixture can be dried to a powder before filling of the containers.

### DETAILED DESCRIPTION OF THE PREFERRED EMBODIMENTS

The present invention is directed to a protein free creamer composition, in liquid or powder form, that is stable for extended periods as the creamer composition, and is also stable when added to a liquid media or a beverage such as coffee. Embodiments directed to liquid protein free creamers include an aseptic liquid creamer that is stable for up to 9 months at ambient temperatures, and an ESL liquid creamer that is stable for up to two months at refrigeration temperatures. The powder form of the protein free creamer is stable for up to 24 months at ambient temperatures.

The protein-free creamer composition is formed by the interaction of oils/fats and carbohydrates, and stabilized by the use of emulsifiers and hydrocolloids. The emulsifying system (or component) includes at least two low molecular weight emulsifiers in relative amounts that are sufficient to provide a stabilized emulsion—both in the creamer, and when the creamer is added to an aqueous media. For stable oil-in-water emulsion, it is expected that emulsifiers with high HLB values provide the best stability. However, it was surprisingly found that a combination of low molecular weight emulsifiers with low and medium HLB values provides the best stability in liquid creamers. It was further found that particular ratios achieve superior emulsion stability.

To achieve the superior emulsion stability of the protein-free creamer composition, the ratio of low HLB value emulsifier to high HLB value emulsifier can range from about (5-1):(1-20), preferably from about (3-1):(1-7), and most preferably from about (1.5-1):(2-4). The total amount of emulsifier can constitute about 0.05 to about 0.8 percent by weight of the total composition.

Low molecular weight emulsifiers with low HLB values can include, but are not limited to, monoglycerides, diglycerides, acetylated monoglycerides, sorbitan trioleate, glycerol dioleate, sorbitan tristearate, propyleneglycol monostearate, glycerol monooleate and monostearate, alone or in combination. The low molecular weight emulsifiers with medium HLB values can include, but are not limited to, sorbitan monooleate, propylene glycol monolaurate, sorbitan monostearate, calcium stearoxyl-2-lactylate, glycerol sorbitan monopalmitate, soy lecithin, and diacetylated tartaric acid esters of monoglycerides, alone or in combination.

The emulsifiers used are not limited to those of a single acyl or fatty acid component, such as on a specific carbon chain length or degree of unsaturation. In preferred embodiments, the emulsifiers are monoglycerides and acid esters of monoglycerides. Particularly preferred embodiments include a combination of monoglycerides and acid esters of monoglycerides.

Surprisingly, it was discovered that the above described emulsion stabilizing system is sufficient only in combination with an MCC/CMC/carrageenan hydrocolloid stabilizing system. Thus, the protein free system with only low molecular weight emulsifiers systems does not prevent physico-chemical instability of liquid coffee creamers without this hydrocolloid stabilizing system. Moreover, hydrocolloid stabilizing systems other than CMC/MCC/carrageenan, in the specific ratios set forth herein, also do not provide physico-chemical stability of protein free liquid creamers. For example, use of the preferred emulsifier system set forth herein, in combination with carrageenan/xanthan/CMC, carrageenan/xanthan/MCC, carrageenan/gellan/MCC, carrageenan/gellan/CMC, guar gum/carrageenan/MCC, and many other combinations, resulted in severe phase separation of liquid creamers.

Accordingly, the protein free creamer composition includes a cellulose component having a blend of microcrystalline cellulose (MCC) and carboxymethylcellulose (CMC), and a carrageenan gum component. The cellulose and gum components are present in an amount that is sufficient to maintain the composition in a homogenous state, such that there is no separation of components, sedimentation, creaming, feathering, gelation, or changes in viscosity. Thus the cellulose and gum components contribute to a hydrocolloid stabilizing system that helps to maintain stability of the creamer composition alone, and also when added to a liquid media.

In accordance with a preferred invention embodiment, the MCC/CMC/carrageenan stabilizing system is present in an amount from about 0.05 to 1 wt %, more preferably from 0.2 to 0.7 wt %, and most preferably from 0.3 to 0.5% by weight of the total composition. Use of less than 0.05% of total hydrocolloids resulted in an off-flavor in the whitener samples, while levels of total hydrocolloids higher than 1% resulted in severe syneresis and creaming of the samples.

The cellulose component of the MCC/CMC blend can be present in an amount of about 0.01 to 1%, preferably about 0.2 to 0.6% by weight of the composition, and most preferably about 0.3 to 0.5% by weight of the composition. The ratio of MCC to CMC is preferably about 8:1 to 12:1, and most preferably about 9:1 to 10:1. Co-processed MCC and CMC may also be used.

The cellulose and gum components can be present together in an amount of about 0.05 to about 1.0 percent by weight of the total composition, with the cellulose and gum components present in a weight ratio of between 200:1 and 1:10.

The carrageenan gum component is preferably present in an amount of about 0.005 to 0.1 percent by weight of the composition, and can be a kappa carrageenan, an iota carrageenan, a lambda carrageenan, or a combination thereof. In accordance with one embodiment of the invention, the carrageenan is a kappa/iota carrageenan blend, in weight to weight ratio of about 6:1 to about 1:10. Suitable examples include those sold under the trade name Seakem or Viscarin, available from FMC Corporation of Philadelphia, Pa.; Grinsted available from Danisco A/S of Denmark.

The weight ratios of MCC/CMC/carrageenan can be in the range of (5-200):(1-30):(1-10), preferably (20-45):(1-10):(1-5), and most preferably (30-40):(1-5):(1-3). A particularly preferred embodiment of the invention includes the emulsifying system of low molecular weight emulsifiers in conjunction with the MCC/CMC/carrageenan stabilizing system and in accordance with these percentages and ratios.

MCC/CMC co-processed with carrageenan, such as kappa-, lambda- and iota-carrageenan, may also be used. Suitable examples of co-processed MCC/CMC/carrageenan include those sold under the trade name Avicel, available from FMC Corporation of Philadelphia, Pa.

It was surprisingly found that addition of the hydrocolloid stabilizing system set forth herein also has significant effect on taste of protein free creamers. For example, aseptic casein-free liquid coffee without hydrocolloids oxidized and developed an undesirable “off” taste after 2 months storage at room temperature. In contrast, sensory evaluation of coffee with the addition of the protein free creamers made in accordance with embodiments of the invention (including the hydrocolloid stabilizing system) demonstrate good mouth-feel, body, smooth texture, and a pleasing taste with no off-flavors or undesirable aftertaste.

The protein free creamer can further include the use of a whitening agent in an amount sufficient to provide whitening to an aqueous media to which the whitening agent is added. In one embodiment, the whitening agent is as titanium dioxide, which can be present in an amount of about 0.1 to about 1% by weight of the composition. The titanium dioxide can have a particle size ranging 0.1 to 0.7 microns, with a preferred embodiment having a particle size of 0.4 microns. Other suitable whitening agents as known in the art can also be use, such as calcium carbonate, calcium sulfate, and aluminum oxide. In another embodiment, the particule size range is of between 0.3 and 0.5 microns. The optimum size of the whitening component is obtained when light scattering is delivering the most intense white color. This is related to the wavelength considered and for the whole visible spectrum the optimum size would be half the average wavelength or around 0.30 microns. It may be expected that a smaller size would make the liquid creamer itself bluish in color, whereas a larger size would progressively decrease the whitening power. Using a particle size around a mean of 0.30 microns should be beneficial at least on two accounts. The increased whitening power results in less of the whitening component needed for the same end color, which allows for a costs reduction. The smaller particles are easier to suspend and keep suspended. Generally speaking suspended particles are governed by the Stokes' law terminal velocity in term of gravitational force providing a tendency for settling. However at particle size lower than about 2.0 microns, other forces become significant and also control the settling or suspension. It is well known that below 2.0 microns Brownian motion predominates and the gravitational forces becomes less and less important as the size is reduced, thus favoring suspension of small particles without much settling(Basic Principles of Particle Size Analysis, Alan Rawle, Malvern Instruments Limited).

The creamer can also include a pH buffer. Preferably, the pH range is about 6 to 8 and more preferably about 6.5 to 7.5. Non-limiting examples of suitable buffers are salts such as potassium phosphate, dipotassium phosphate, potassium hydrophosphate, sodium bicarbonate, sodium citrate, sodium phosphate, disodium phosphate, sodium hydrophosphate, and sodium tripolyphosphate. The buffer can be present in an amount of about 0.5 to about 1% of the total weight of the composition.

Optionally, the creamer can contain sweeteners, including but not limited to sucrose, fructose, maltodextrin, high fructose corn syrup, other natural sweeteners, artificial sweeteners, or combination of thereof. The sweeteners may be present in concentration from about 0.1 to 50%, and preferably from about 5 to 30% by weight of the total composition. The whiteners can also include added colors and/or flavors.

Both liquid and powder creamers may contain from about 0.1 to 33 wt % of vegetable oil(s). The vegetable oil(s) can include partially or wholly hydrogenated oils, alone or in combination. Suitable vegetable oils include, but are not limited to, soybean oil, coconut oil, palm oil, cotton seed oil, canola oil, olive oil, sunflower oil, safflower oil.

The liquid creamer can have a total solid content between about 5 to 65%, preferably about 10-50%, and most preferably about 12-45% by weight of the total composition. When combined with an aqueous beverage such as coffee, the resulting liquid can have a solid content of from about 0.5 to 10%, preferably about 4-8%, and most preferably about 5-6% weight of the total composition. The creamer can be full fat, low fat, or reduced fat.

The powder creamer can have a particle size of about 100 to about 4000 microns, preferably 500 to 3000, and most preferably about 1000 to 2000. The powder creamer can be bed dried, spray dried, freeze dried, agglomerated, or prepared in accordance with other techniques as known in the art.

Embodiments of the invention include the creamer compositions set forth herein, further in combination with water in an amount sufficient to make a liquid creamer. An exemplary embodiment of the invention includes a creamer with the cellulose component present in an amount of 0.05 to 1.0% by weight; the gum component present in an amount of 0.005 to 0.1% by weight; the emulsifying component present in an amount of 0.05 to 0.8% by weight; and water present in an amount of 35 to 95% by weight. Additional embodiments of the invention also extend to a beverage including the creamer composition and an aqueous liquid, to make a dairy replacement that is suitable for consumption with food or for use in cooking In another embodiment, the creamer is added to a beverage in an amount sufficient to provide a creaming effect to the beverage. A creaming effect imparts qualities associated with cream or dairy such as desirable, flavor, texture, body, and color (lightening or whitening).

The beverage can have a solid content of about 0.5 to about 10% by weight of the total beverage. The beverage can further include a beverage forming component such as coffee, tea, chocolate, or a fruit drink. The beverage forming component can also be a powder or crystal substance, typically having some sort of flavor, such as cocoa, malt, or fruit flavor crystals. The invention also extends to the use of a creamer as a dairy replacement that can be consumed directly or with other foodstuffs such as cereal.

The liquid ESL, aseptic, and powder creamers set forth herein were formulated to produce a beverage with good mouth-feel and body, smooth texture, and a pleasant taste with no off-flavors. In particular, the creamers were formulated to be compatible with a hot acidic beverage such as coffee, but include a much broader range of use. For example, the liquid and powder creamers described herein can be used for addition to other liquid beverages, to soups, and for use in cooking.

With the new stabilizing systems set forth herein, the ESL liquid creamers are physico-chemical stable for at least 120 days at refrigeration temperatures (4-8° C.) and aseptic liquid creamers are shelf-stable at least for 9 months at room temperature (about 20-25° C.) and elevated temperatures (about 30-38° C.). The liquid creamers have a total solid content between 5 to 65%, preferably 10-50%, most preferably 12-45%. Both aseptic and ESL products maintain manageable viscosity over full life of the products.

The present invention further provides a process of making ESL and aseptic shelf stable liquid coffee creamers which includes providing the emulsifying components, cellulose components, and carrageenan gum components, in powder form and dissolving the powdered components in hot water under agitation. Other optional components such as sweetener or whitening agent, in powder form, can be included in this step. Next, melted oil/fat is added to the hot water to produce a mixture of all components. The mixture then undergoes UHT treatment, homogenization, cooling, and filling in ESL or in aseptic containers under aseptic conditions. Homogenization can be performed before and/or after heat treatment.

The process of manufacture of the powder creamer includes dissolving the powder components in water under agitation, addition of melted fat/oil, followed by pasteurization, homogenization, drying, cooling, and filling.

The advantages of the present invention are numerous. First, the invention achieves a protein-free, true non-dairy creamer, without the use of casein or its derivatives. Creamers with the stabilizing systems as set forth herein achieve superior stability, with no separation, creaming, gelation, syneresis, or sedimentation. The creamers do not oxidize or discolor, and provide a high whitening capacity. They are easily dispersible in liquid media, and are stable even in hot, acidic environments. The creamers display good mouth-feel, body, a smooth texture, and pleasing flavor without any off-notes, both alone and when added to beverages. The elimination of the need for milk proteins such as casein also provides a significant cost reduction. Additionally, when titanium dioxide is used as a complementary whitener, the TiO₂ is maintained in full suspension throughout the creamer shelf-life under all temperature conditions.

The embodiments and examples illustrated and discussed in this specification are intended only to teach those skilled in the art the best way known to the inventors to make and use the invention. The above-described embodiments of the invention may be modified or varied, without departing from the invention, as appreciated by those skilled in the art in light of the above teachings. Accordingly, all expedient modifications readily attainable by one of ordinary skill in the art from the disclosure set forth herein, or by routine experimentation therefrom, are deemed to be within the spirit and scope of the invention as defined by the appended claims.

1. A protein-free creamer composition comprising:
an emulsifying component comprising at least two different low molecular weight emulsifiers in relative amounts sufficient to provide a stabilized emulsion;
a cellulose component comprising a blend of two different cellulose compounds in an amount sufficient to maintain homogeneity of the composition;
a carrageenan gum component present in an amount sufficient to maintain homogeneity of the composition;
the creamer composition is in a form selected from the group consisting of an aseptic liquid creamer that is stable at ambient temperature for at least about 9 months before opening, a liquid creamer that has an extended-shelf life (ESL) and is stable for at least about four months at refrigeration temperatures; and a powder that is stable for at least 24 months at ambient temperatures; and
the liquid aseptic creamer, the liquid ESL creamer and the powder creamer provides sufficient whitening capacity and a pleasant mouth feel without discernable feathering and without visually discernable fat separation when added to liquid beverages.

2. The composition of claim 1, wherein the emulsifier component includes a combination of at least one low HLB emulsifier and at least one medium HLB emulsifier in a weight ratio of about 5:1 to about 1:20 with the low and medium HLB emulsifiers both being present in an amount of about 0.05 to 0.8% by weight of the total composition.

3. The composition of claim 2, wherein the low HLB emulsifier is selected from the group consisting of a monoglyceride, diglyceride, acetylated monoglyceride, sorbitan trioleate, glycerol dioleate, sorbitan tristearate, propyleneglycol monostearate glycerol, monooleate and monostearate, and a combination thereof, and the medium HLB emulsifier is selected from the group consisting of sorbitan monooleate, propylene glycol monolaurate, sorbitan monostearate, calcium stearoxyl-2-lactylate, glycerol sorbitan monopalmitate, soy lecithin, diacetylated tartaric acid esters of monoglycerides, and a combination thereof.

4. The composition according to claim 1, wherein the cellulose component is a blend of microcrystalline cellulose (MCC) and carboxymethylcellulose (CMC) present in a total amount of about 0.05 to about 1 percent by weight of the composition, with the MCC and CMC present in a weight ratio of about (5-200):(1-30).

5. The composition according to claim 1, wherein the carrageenan gum component is present in an amount of about 0.005 to about 0.1 percent by weight of the composition.

6. The composition of claim 5, wherein the carrageenan gum component is selected from the group consisting of a kappa carrageenan gum, an iota carrageenan gum, a lamdda carrageenan gum, and a combination thereof.

7. The composition of claim 5, wherein the carrageenan gum component is a combination of a kappa carrageenan and an iota carrageenan in a weight ratio of about 6:1 to about 1:10.

8. The composition according to claim 1, wherein the carrageenan gum component and the cellulose component are provided as a co-processed composition comprising the carrageenan gum component and cellulose component.

9. The composition according to claim 1, further comprising an ingredient selected from the group consisting of a pH buffer, a sweetener in an amount of about 0.1 to about 50 percent by weight of the composition, and a vegetable oil in an amount of about 0.1 to about 33 percent by weight of the composition.

10. The composition according to claim 1 comprising a whitening agent in an amount sufficient to provide additional whitening to an aqueous media to which the creamer is added.

11. The composition of claim 10, wherein the whitening agent is titanium dioxide having a particle size of about 0.1 to about 0.7 microns and present in an amount of about 0.1 to about 1 percent by weight of the composition.

12. The composition according to claim 1 in the form of a powder creamer having a particle size of about 100 to about 4000 microns.

13. The composition according to claim 1 comprising water in an amount sufficient to make a liquid creamer.

14. The composition of claim 13 wherein the creamer is selected from the group consisting of a full-fat, low-fat and non-fat liquid composition and has a total solids content between about 5 to about 65 percent by weight of the composition.

15. The composition according to claim 1, wherein
the emulsifying component includes a combination of at least one low HLB emulsifier and at least one medium HLB emulsifier in a weight ratio of about 5:1 to about 1:20 with the low and medium HLB emulsifiers both being present in an amount of about 0.05 to 0.8% by weight of the total composition;
the cellulose component is a blend of microcrystalline cellulose (MCC) and carboxymethylcellulose (CMC) present in a total amount of about 0.05 to about 1 percent by weight of the composition, with the MCC and CMC present in a weight ratio of about 3:1 to about 30:1; and
the carrageenan gum component is selected from the group consisting of a kappa carrageenan gum, an iota carrageenan gum, a lambda carrageenan gum, and a combination thereof and is present in an amount of about 0.005 to about 0.1 percent by weight of the composition.

16. A beverage comprising an aqueous liquid, a beverage-forming component, and a creamer composition comprising: an emulsifying component comprising at least two different low molecular weight emulsifiers in relative amounts sufficient to provide a stabilized emulsion; a cellulose component comprising a blend of two different cellulose compounds in an amount sufficient to maintain homogeneity of the composition; a carrageenan gum component present in an amount sufficient to maintain homogeneity of the composition; the creamer composition is in a form selected from the group consisting of an aseptic liquid creamer that is stable at ambient temperature for at least about 9 months before opening, a liquid creamer that has an extended-shelf life (ESL) and is stable for at least about four months at refrigeration temperatures; and a powder that is stable for at least 24 months at ambient temperatures; and the liquid aseptic creamer, the liquid ESL creamer and the powder creamer provides sufficient whitening capacity and a pleasant mouth feel without discernable feathering and without visually discernable fat separation when added to liquid beverages in an amount sufficient to provide a creaming effect to the beverage.

17. The beverage of claim 16 wherein the beverage-forming component is selected from the group consisting of coffee, tea, chocolate and a fruit drink.

18. A dairy replacement for consumption with food or for use in cooking and comprising a protein-free creamer composition comprising:
an emulsifying component comprising at least two different low molecular weight emulsifiers in relative amounts sufficient to provide a stabilized emulsion;
a cellulose component comprising a blend of two different cellulose compounds in an amount sufficient to maintain homogeneity of the composition;
a carrageenan gum component present in an amount sufficient to maintain homogeneity of the composition;
the creamer composition is in a form selected from the group consisting of an aseptic liquid creamer that is stable at ambient temperature for at least about 9 months before opening, a liquid creamer that has an extended-shelf life (ESL) and is stable for at least about four months at refrigeration temperatures; and a powder that is stable for at least 24 months at ambient temperatures; and
the liquid aseptic creamer, the liquid ESL creamer and the powder creamer provides sufficient whitening capacity and a pleasant mouth feel without discernable feathering and without visually discernable fat separation when added to liquid beverages.

19. A process for the manufacture of a creamer composition comprising providing emulsifying components, cellulose components, and carrageenan gum components, in powder form; and dissolving the powder components in hot water with agitation to provide a composition comprising a protein-free creamer composition comprising: an emulsifying component comprising at least two different low molecular weight emulsifiers in relative amounts sufficient to provide a stabilized emulsion; a cellulose component comprising a blend of two different cellulose compounds in an amount sufficient to maintain homogeneity of the composition; a carrageenan gum component present in an amount sufficient to maintain homogeneity of the composition; the creamer composition is in a form selected from the group consisting of an aseptic liquid creamer that is stable at ambient temperature for at least about 9 months before opening, a liquid creamer that has an extended-shelf life (ESL) and is stable for at least about four months at refrigeration temperatures; and a powder that is stable for at least 24 months at ambient temperatures; and the liquid aseptic creamer, the liquid ESL creamer and the powder creamer provides sufficient whitening capacity and a pleasant mouth feel without discernable feathering and without visually discernable fat separation when added to liquid beverages.

20. The method of claim 19, comprising adding a sweetener or whitening agent, in powder form, into the hot water with agitation.

21. The method of claim 19, comprising adding a vegetable oil or fat to the hot water to produce a mixture of all components, followed by subjecting the mixture to UHT treatment, homogenization, cooling, and filling in containers under aseptic conditions.

22. The method of claim 19, comprising adding a vegetable oil or fat to the hot water to produce a mixture of all components, followed by subjecting the mixture to UHT treatment, homogenization, cooling, drying to a powder and filling the powder into containers under aseptic conditions.
